(19) United States
(12) Patent Application Publication
(10) Pub. No.: US 2025/0247042 A1
(43) Pub. Date: Jul. 31, 2025

(54) BUILDING INTEGRATED PHOTOVOLTAIC SYSTEM

(71) Applicant: Energy ReLeaf, Minneapolis, MN (US)

(72) Inventors: Peter Reese, Minneapolis, MN (US); Paul Reese, Goodhue, MN (US)

(21) Appl. No.: 19/040,047

(22) Filed: Jan. 29, 2025

Related U.S. Application Data
(60) Provisional application No. 63/609,892, filed on Jan. 29, 2024.

(51) Int. Cl. H02S 20/25; H02M 7/00; H02S 10/20; H02S 20/26; H02S 30/10

(52) U.S. Cl. CPC H02S 20/25; H02M 7/003; H02S 10/20; H02S 20/26; H02S 30/10

(57) ABSTRACT

A building integrated photovoltaic (BIPV) system. The BIPV system includes a plurality of photovoltaic elements. A cable couples the plurality of photovoltaic elements to an energy storage. A plurality of cladding backplates secure the plurality of photovoltaic elements to a building envelope. Each of the cladding backplates including an upper ridge and a lower ridge to secure the photovoltaic element therebetween. A connection tab is positioned on a lateral side of the cladding backplate.

### TECHNICAL FIELD

The subject matter disclosed herein relates to the field of solar energy production and, in particular, to devices, systems and methods for building integrated photovoltaics (BIPV).

### BACKGROUND

In general, photovoltaics (PV) such as solar panels, can be used to convert sunlight into electricity. PV cells, or solar cells, are made of semiconductor materials that absorb photons from sunlight. The absorbed photons generate energy that creates an electric current. The electrical current can be stored within the PV system and/or communicated to external systems to provide electrical power.

### SUMMARY

According to one aspect, a building integrated photovoltaic (BIPV) system. The BIPV system includes a plurality of photovoltaic elements. A cable couples the plurality of photovoltaic elements to an energy storage. A plurality of cladding backplates secure the plurality of photovoltaic elements to a building envelope. Each of the cladding backplates including an upper ridge and a lower ridge to secure the photovoltaic element therebetween. A connection tab is positioned on a lateral side of the cladding backplate. A channel extends into the cladding backplate to receive the cable therein.

According to another aspect, a cladding backplate for securing photovoltaic elements to a building envelope, the cladding backplate includes a front surface including an upper ridge and a lower ridge with a recessed portion therebetween to receive a photovoltaic element, and a front channel extending into the front surface. A rear surface includes a rear channel extending into the rear surface. A connection tab is positioned on a lateral side of the cladding backplate. The front channel and the rear channel form a cable raceway to retain a cable from the photovoltaic element.

According to another aspect, a method for mounting photovoltaic elements to a building envelope. The method includes mounting a plurality of cladding backplates to the building envelope. Each of the plurality of cladding backplates includes a front surface having an upper ridge and a lower ridge with a recessed portion therebetween. A photovoltaic element is mounted to the cladding backplate. The photovoltaic element is received in the recessed portion of the cladding backplate. The photovoltaic element is electrically coupled to an energy storage system via a cable.

### BRIEF DESCRIPTION OF THE DRAWINGS

FIG. 1 is a diagrammatic side view of a building integrated photovoltaic (BIPV) system, according to some embodiments.

FIG. 2A is a front view of an array of cladding backplates for securing a plurality of photovoltaic elements, according to some embodiments.

FIG. 2B is a front view of the backplate for securing a solar cell module (not shown), according to some embodiments.

FIG. 2C is a rear view of the backplate for securing a photovoltaic element, according to some embodiments.

FIG. 2D is an isometric front view of the backplate for securing a photovoltaic element, according to some embodiments.

FIG. 2E is an isometric rear view of the backplate for securing a photovoltaic element, according to some embodiments.

FIG. 3A is an exploded isometric view of a through-roof enclosure for building integrated photovoltaic (BIPV) system, according to some embodiments.

FIG. 3B is a front view of the through-roof enclosure installed between adjacent backplates, according to some embodiments.

FIG. 4 is a diagrammatic view of an array of photovoltaic elements electrically coupled, according to some embodiments.

FIG. 5 is a diagrammatic top view of a micro inverter for a building integrated photovoltaic (BIPV) system, according to some embodiments.

FIG. 6 is a diagrammatic view of an alternative mounting box for a building integrated photovoltaic (BIPV) system, according to some embodiments.

FIG. 7 is a diagrammatic view of a microgrid interconnect device for a building integrated photovoltaic (BIPV) system, according to some embodiments.

FIG. 8 is a flow chart of a method for mounting photovoltaic elements to a building envelope, according to some embodiments.

### DETAILED DESCRIPTION

The present disclosure describes a building integrated photovoltaic (BIPV) system configured to improve ease of installation, maintenance, safety, durability, and aesthetic appearance. The BIPV system includes a plurality of cladding backplates to mount a plurality of photovoltaic elements, such as solar cell modules (e.g., solar panels and/or solar shingles), thereto. The plurality of cladding backplates and the plurality of solar cell modules are configured to interlock and/or overlap to form a water, ice, and debris barrier to protect the building envelope. An electronics enclosure is positioned between adjacent cladding backplates. The electronics enclosure extends through the building envelope (i.e., the roof or side wall of the building) to couple the plurality of photovoltaic elements to a hybrid micro inverter and/or a rapid shutdown device (RSD).

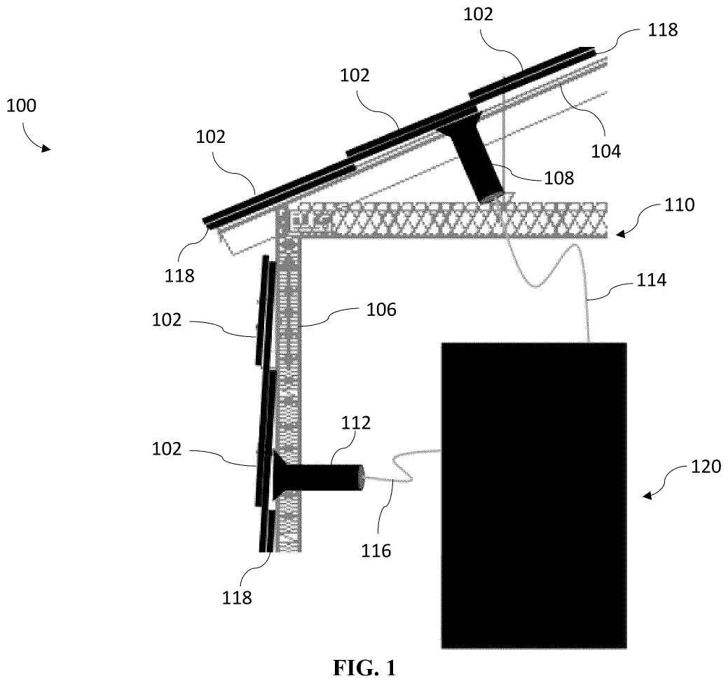

FIG. 1 is a diagrammatic side view of a building integrated photovoltaic (BIPV) system 100, according to some embodiments. The BIPV system 100 includes a plurality of photovoltaic elements 102 (e.g., solar panels and/or solar shingles) mounted to a roof 104 and a side wall 106 of a building 110 (the roof 104 and the side wall 106 forming a building envelope). A first electronics enclosure 108 extends through the roof 104 and a cable 114 electrically couples the plurality of photovoltaic elements 102 to a solar management system 120. A second electronics enclosure 112 extends through the side wall 106 and a cable 116 couples the plurality of photovoltaic elements 102 to a solar management system 120. Each of the plurality of photovoltaic elements 102 may be mounted to the roof 104 and the side wall 106 via a cladding backplate 118. The cladding backplate 118 is positioned between the building envelope (e.g., the roof 104 and/or the side wall 106) and the photovoltaic elements 102.

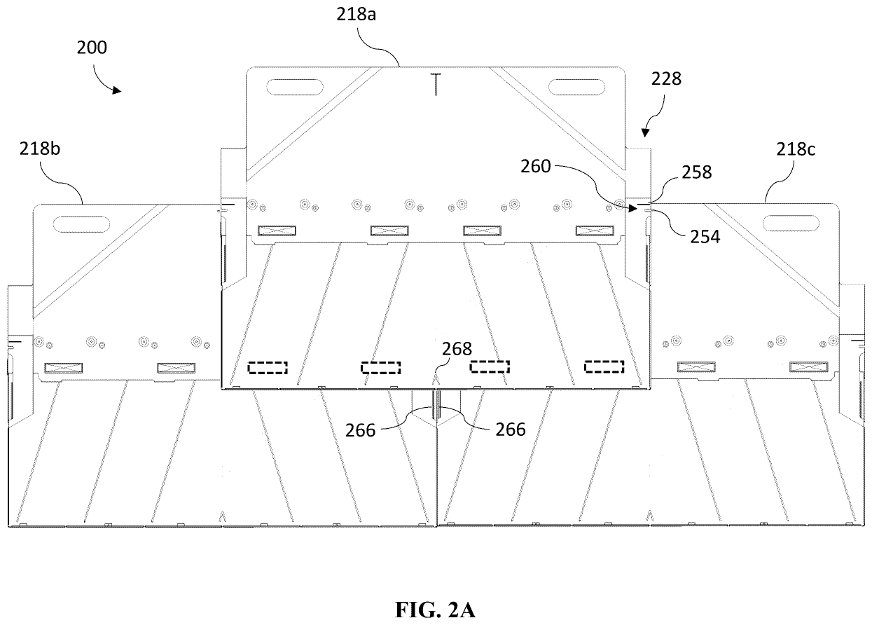

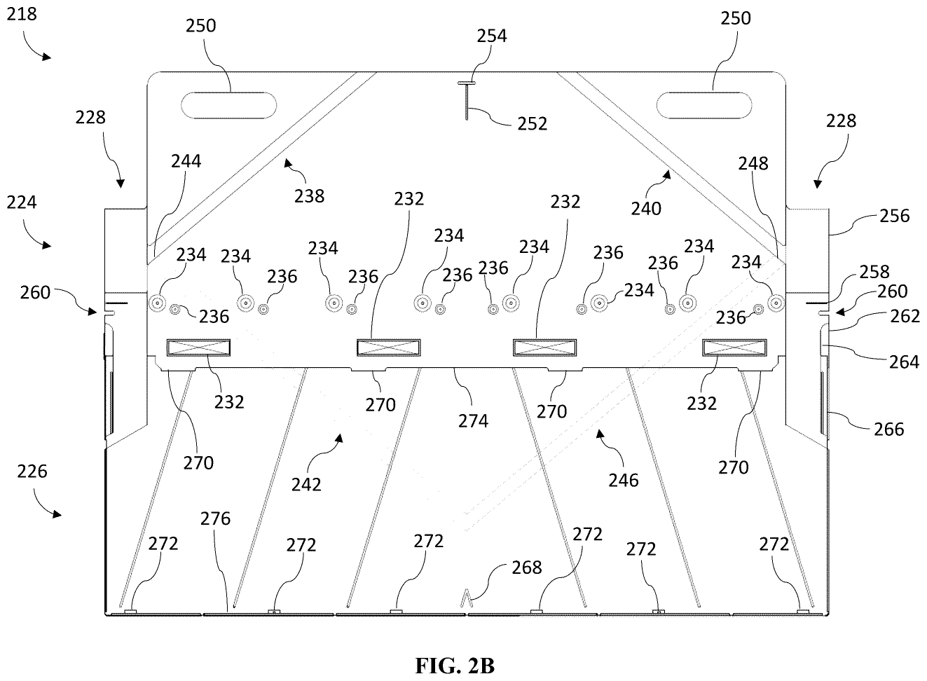

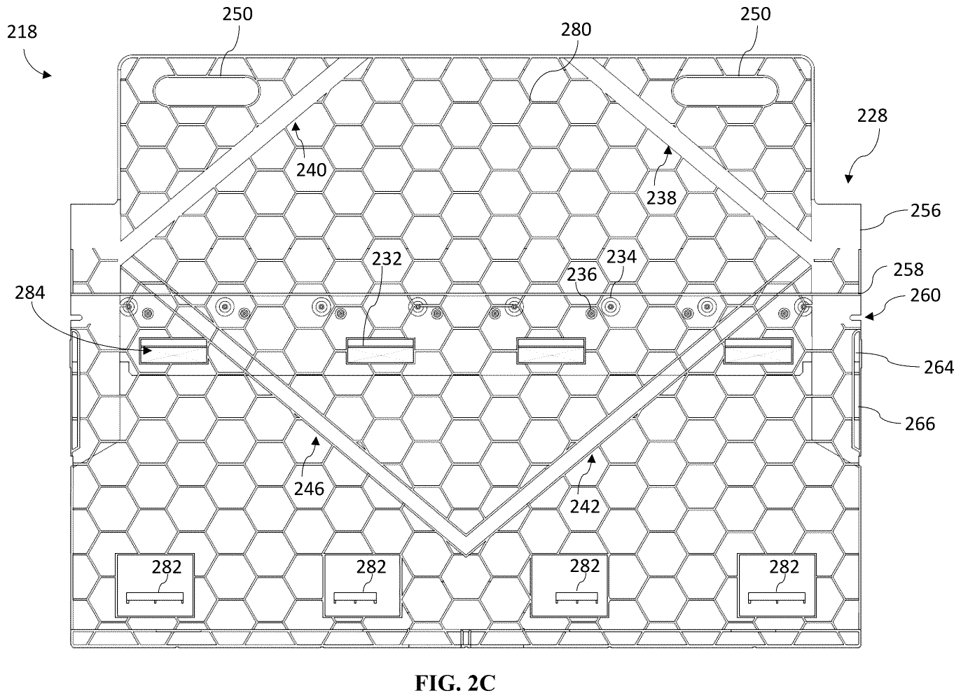

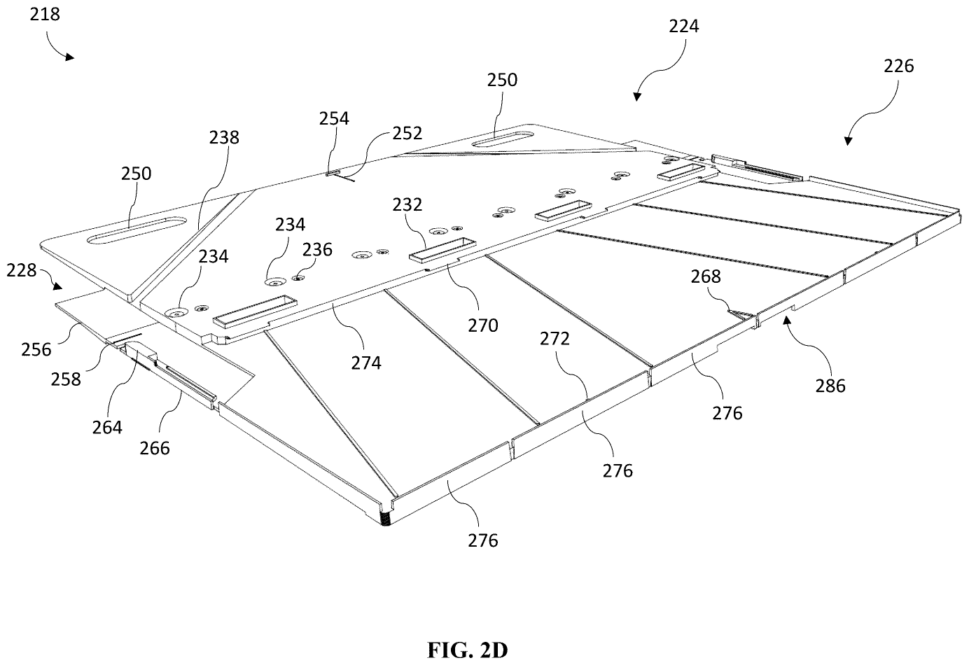

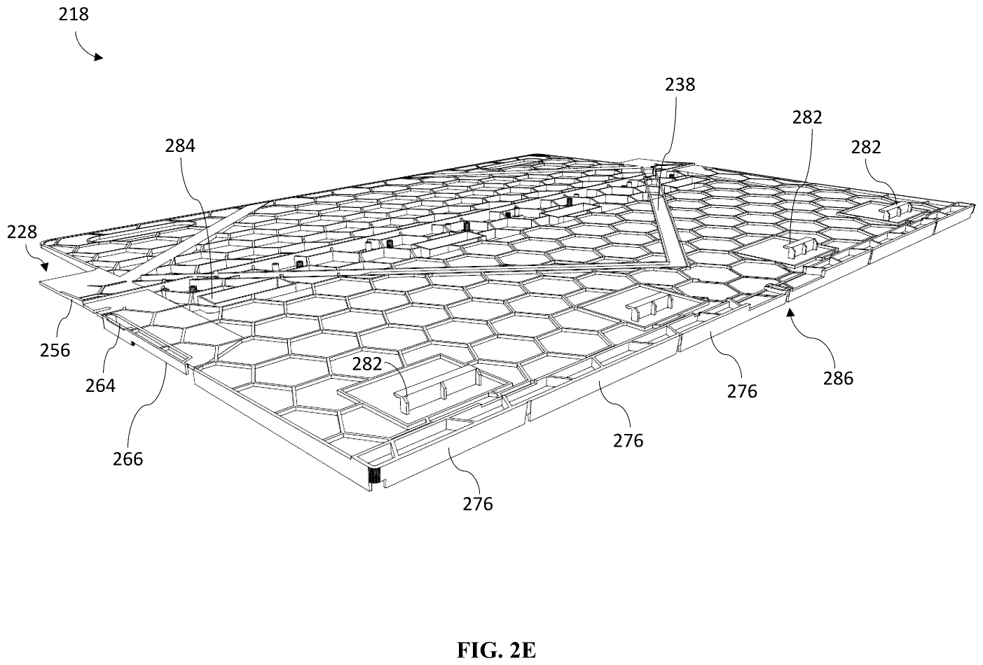

FIG. 2A is a front view of an array of cladding backplates 200 for securing a plurality of photovoltaic elements (not shown), according to some embodiments. The array of cladding backplates 200 includes a first cladding backplate 218a, a second cladding backplate 218b, and a third cladding backplate 218c. The cladding backplates 218a, 218b, 218c may be identical to each other, and therefore may be referred to generally as the backplate 218. The features/elements of the backplate 218 are described in FIGS. 2B-C.

FIG. 2B is a front view of the backplate 218 for securing a photovoltaic element (not shown), according to some embodiments. The backplate 218 includes an upper plate portion 224, a lower plate portion 226, and one or more connection tabs 228. The upper plate portion 224 is configured to be covered by one or more adjacent backplates 218 (see e.g., FIG. 2A with first cladding backplate 218a partially covering the upper portion of the second cladding backplate 218b and the third cladding backplate 218c). The upper plate portion 224 includes a plurality of front attachment members 232. The plurality of front attachment members 232 may include a cavity extending into the backplate 218 configured to receive a rear attachment member of an adjacent backplate. The upper plate portion 224 includes a plurality of first mounting apertures 234. The plurality of first mounting apertures 234 may be configured to receive fastener (e.g., a roofing nail or screw) therethrough to secure the backplate 218 to the building envelope. The upper plate portion 224 may include a plurality of second mounting apertures 236 configured to receive fastener (e.g., a roofing nail or screw) therethrough to secure the backplate 218 to the building envelope. The plurality of second mounting apertures 236 may be utilized as a backup aperture if the first mounting aperture 234 is damaged or unavailable for receiving a fastener.

The upper plate portion 224 includes a first channel 238 and/or a second channel 240 extending into the backplate 218. The first channel 238 and/or the second channel 240 may be configured to receive a cable therein and route the cable (i.e., provide a cable raceway) to a desired location. The first channel 238 may be adjacent to, and in communication with, a third channel 242 via an opening 244. The second channel 240 may be adjacent to, and in communication with, a fourth channel 246 via an opening 248. A cable may therefore be routed from the third channel 242 to the first channel 238 (and vice-versa). The first channel 238 and the second channel 240 may be front facing channels (i.e., exposing the cable on the front side of the backplate 218) and the third channel 242 and the fourth channel 246 may be rear facing channels (i.e., exposing the cable on the rear side of the backplate 218). The channels 238, 240, 242, 246 (together referred to as the raceway) are positioned around, and do not intersect with, the plurality of first mounting apertures 234 and the plurality of second mounting apertures 236. The raceway integrated into the surfaces of the backplate 218 is beneficial, as it provides reliable cable control through the backplate 218 without needing to couple the cable at the periphery of each backplate 218. The raceway integrated into the surfaces of the backplate 218 minimizes risk of cable damage due to interference with the mounting apertures and fasteners.

The upper plate portion 224 may include one or more handles 250 configured to provide a handling surface for the installer. The upper plate portion 224 may include a vertical alignment tab 252 and/or a horizontal alignment tab 254. The vertical alignment tab 252 and/or the horizontal alignment tab 254 is configured to engage the connection tab 228 of an adjacent backplate. The vertical alignment tab 252 and the horizontal alignment tab 254 may thereby provide proper alignment of the adjacent backplate.

The connection tab 228 includes a base portion 256, a ridge 258, a horizontal channel 260, a vertical stop surface 262, a protrusion 264, and a vertical ridge 266, according to some embodiments. The base portion 256 may be coupled to the lower portion of the connection tab 228 via the ridge 258. The ridge 258 may be configured to engage an upper surface of an upper plate portion 224 of an adjacent backplate (see e.g., FIG. 2A, the ridge 258 of the first cladding backplate 218a engaging the upper surface of the third cladding backplate 218c). The horizontal channel 260 may be configured to receive the horizontal alignment tab 254 of an adjacent backplate (see e.g., FIG. 2A, the horizontal alignment tab 254 of the third cladding backplate 218c is received within the horizontal channel 260 of the first cladding backplate 218a). The vertical stop surface 262 may be configured to engage the vertical alignment tab 252 of an adjacent backplate. The ridge 258, the horizontal channel 260, and/or the vertical stop surface 262 may align the backplate 218 with the adjacent backplate. In some embodiments, the ridge 258, the horizontal channel 260, and/or the vertical stop surface 262 may provide visual and/or tactile configuration of proper alignment and seating of the backplate 218 within the array of cladding backplates. In some embodiments, the protrusion 264 is configured to receive the vertical alignment tab 252 therein.

The vertical ridge 266 of the connection tab 228 may be configured to abut an adjacent vertical ridge of an adjacent backplate. For instance, FIG. 2A shows the vertical ridge 266 of the second cladding backplate 218b engaging the vertical ridge 266 of the third cladding backplate 218c. An alignment indicator 268 on an adjacent backplate may provide visual and/or tactile confirmation of proper alignment of adjacent vertical ridge 266 members on adjacent backplates.

The lower plate portion 226 includes a plurality of upper tabs 270 extending from an upper ridge 274 and a plurality of lower tabs 272 extending from a lower ridge 276. The region in between the upper ridge 274 and the lower ridge 276 is recessed from the upper plate portion 224, such that one or more solar elements (e.g., solar panels or solar shingles) can be housed therein. For instance, solar elements may be slid under the plurality of upper tabs 270 and secured to the backplate 218 via a fastener/connector inserted through the plurality of lower tabs 272. The solar elements are thereby coupled to the lower plate portion 226 via the plurality of upper tabs 270 and the plurality of lower tabs 272. In some embodiments, a plurality of solar elements are coupled to the lower plate portion 226. For instance, each of the plurality of lower tabs 272 may secure a solar element, such that the embodiment shown in FIG. 2B may secure six solar elements. The vertical ridge 266 of the connection tab 228 may engage the solar elements on the lateral ends of the lower plate portion 226 to secure the solar elements and/or to prevent lateral movement of the solar elements.

The lower plate portion 226 includes solar element (e.g., solar panel and/or solar shingle) mounting features integrated into the backplate 218. In other words, the plurality of upper tabs 270, the plurality of lower tabs 272, the upper ridge 274, the lower ridge 276, and/or the vertical ridge 266 are configured to secure and mount solar elements without requiring external frames or mounting components. In some embodiments, the solar element may be placed in the lower plate portion 226 (e.g., between the upper ridge 274 and the lower ridge 276) and a single fastener may secure each solar element at the plurality of lower tabs 272.

FIG. 2C is a rear view of the backplate 218 for securing a photovoltaic element (not shown), according to some embodiments. The backplate 218 includes a honeycomb frame 280. The honeycomb frame 280 may extend rearward from the backplate 218 to provide a lightweight structural support for the backplate 218 and/or to space the backplate 218 from the building envelope. The backplate 218 may include one or more rear attachment members 282 extending rearward from the backplate 218. The rear attachment member 282 may be received within a through-plate aperture 284 of the front attachment member 232 of an adjacent backplate. For instance, the rear attachment member 282 may be received through the through-plate aperture 284 and engage the front attachment member 232 to secure and align adjacent backplates together.

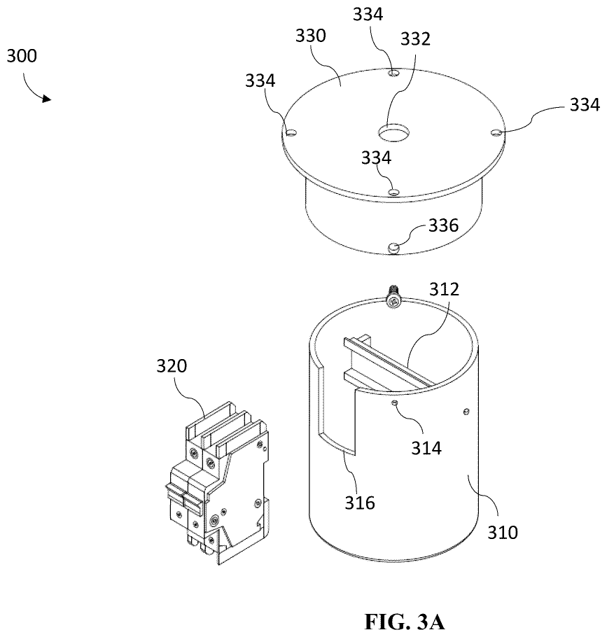

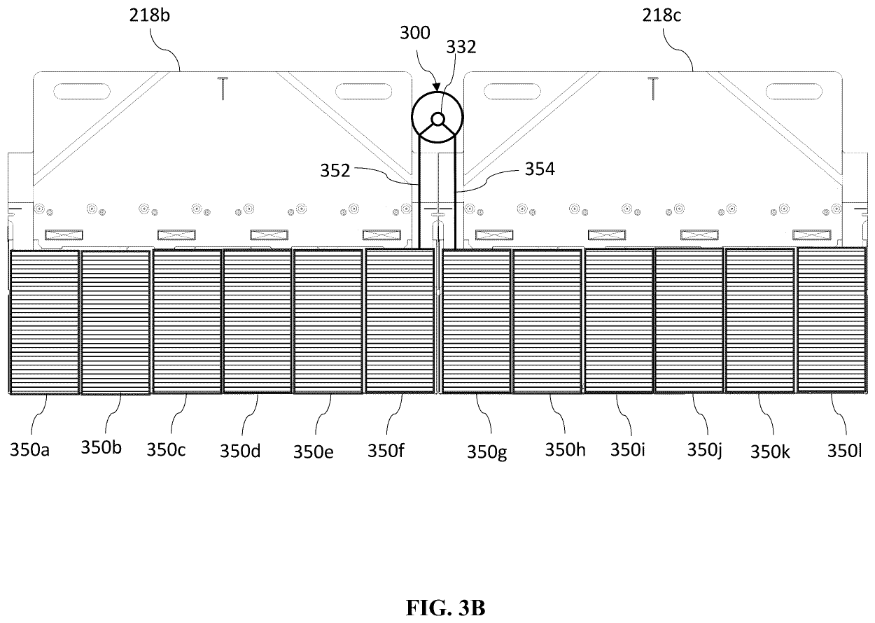

FIG. 2D is an isometric front view of the backplate 218 for securing a photovoltaic element (not shown), according to some embodiments. The upper plate portion 224 may be raised above (i.e., disposed on a plane above) the lower plate portion 226 and/or the connection tab 228. For instance, the lower plate portion 226 may include a recessed portion positioned between the upper ridge 274 and the lower ridge 276 to receive one or more photovoltaic elements (e.g., solar panels or solar shingles) therein. The one or more photovoltaic elements may be secured via the plurality of upper tabs 270 and the plurality of lower tabs 272. The connection tab 228 may be recessed below the upper plate portion 224 to allow a cable (or other conductive connector) to extend from a photovoltaic element on the lower plate portion 226 to the first channel 238 and/or to a through-roof enclosure (see e.g., FIG. 3B). The lower plate portion 226 may include a rear cavity 286 positioned at the lower ridge 276 to allow cables to pass therethrough.

FIG. 2E is an isometric rear view of the backplate 218 for securing a photovoltaic element (not shown), according to some embodiments. The backplate 218 includes the one or more rear attachment members 282 extending rearward from the backplate 218. In some embodiments, the rear attachment member 282 includes an L-shaped retention member configured to slidingly engage the front attachment member 232. The L-shaped retention member may include a cantilevered portion configured to align and secure the backplate 218 to an adjacent backplate.

The backplate 218 provides a single-piece mounting mechanism for the photovoltaic element(s). For instance, instead of providing a backplate, an alignment/connection feature, a wire harness, a photovoltaic frame, etc. as separate components, the backplate 218 provides alignment, retention, framing, and wire control features in a single part. The single-piece mounting mechanism is beneficial, as it reduces installation time and reduces manufacturing costs. For instance, the channels 238, 240, 242, 246 integrated within the backplate 218 reduce the need for external raceways/cable harnesses, providing for quicker, cheaper, and more reliable installation of photovoltaic element(s).

The backplate 218 is a modular component, i.e., can be secured together with adjacent backplates in a repeatable/interchangeable manner. The modularity of the backplate 218 is beneficial, as unique arrays of backplates can be installed to maximize roof coverage. The modularity of the backplate 218 may also improve installation, as a single part (i.e., the backplate 218) can be used across an entire building envelope (as compared to a plurality of different mounting components which may be difficult to properly align, secure, and frame).

The backplate 218 may be configured to secure photovoltaic elements, as well as aesthetic blanks, transitional blanks, and ridge/hip finishing pieces. For instance, if a building envelope includes a pipe/chimney, aesthetic blanks, transitional blanks, and/or ridge/hip finishing pieces may be received within the backplate 218 to provide aesthetic coverage around the obstruction.

FIG. 3A is an exploded isometric view of a through-roof enclosure 300 for building integrated photovoltaic (BIPV) system (e.g. the BIPV system 100), according to some embodiments. The through-roof enclosure 300 may include a housing 310, a breaker 320, and a cylinder cover 330. The housing 310 includes a bracket 312 mounted within the housing 310 and a slot 316 configured to receive the 320/therethrough. The bracket 312 may be configured to mount the breaker 320. The cylinder cover 330 includes an aperture 332 configured to receive a cable (or conductor) therethrough. The cylinder cover 330 includes a plurality of first apertures to receive a fastener to secure the through-roof enclosure 300 to the building envelope. The cylinder cover 330 includes a plurality of second apertures 336 to receive a fastener to secure the cylinder cover 330 to the housing 310. The breaker 320 may be a DC disconnect breaker.

FIG. 3B is a front view of the through-roof enclosure 300 installed between adjacent backplates 218b, 218c, according to some embodiments. A plurality of photovoltaic elements 350a, 350b, 350c, 350d, 350e, 350f, 350g, 350h, 350i, 350j, 350k, 350l (together the photovoltaic elements 350) are secured to the backplates 218b, 218c. The through-roof enclosure 300 is positioned between the second cladding backplate 218b and the third cladding backplate 218c. In some embodiments, the through-roof enclosure 300 is positioned adjacent to the connection tabs 228 of the backplates 218b, 218c. A first cable 352 is electrically coupled to the photovoltaic elements 350a, 350b, 350c, 350d, 350e, 350f and a second cable 354 is electrically coupled to the photovoltaic elements 350g, 350h, 350i, 350j, 350k, 350l. The first cable 352 and the second cable 354 are received through the aperture 332 of the through-roof enclosure 300.

The through-roof enclosure 300 may be manufactured of extruded anodized aluminum tube. Length of the housing 310 may vary depending on components required for the application, amount of battery storage desired by customers, and thickness of building envelope. The housing 310 may contain a full hybrid microinverter, a battery storage, and/or the breaker 320. The cylinder cover 330 may be identical for all models to enable consistency in roof installation across all markets.

In some embodiments, between every 10-15 backplates (at solar professional discretion depending on cold temperature adjustment of project location and/or jurisdictional preferences) a hole may be cut through the building envelope (e.g., a 5 inch hole) for the through-roof enclosure 300 to be inserted therein. The connector harness (e.g., the first cable 352 and the second cable 354) from the photovoltaic elements 350 are inserted into the through-roof enclosure 300. The circuit may remain open until the second string of 10-15 (80 Voc cold temperature adjusted) modules is installed, end of circuit returns are connected, and worker inside building wires AC side and closes breaker on micro inverter. An adjacent backplate (e.g., the first cladding backplate 218a in FIG. 2A) may be placed over the through-roof enclosure 300.

The through-roof enclosure 300 positioned between adjacent backplates 218b, 218c is beneficial, as it provides a protected entrance point for cables into the building envelope. The through-roof enclosure 300 is positioned under an adjacent backplate (e.g., the first cladding backplate 218a in FIG. 2A) to protect the entrance to the building envelope from water and debris. Sealing elements and/or insulation elements may be used therewith.

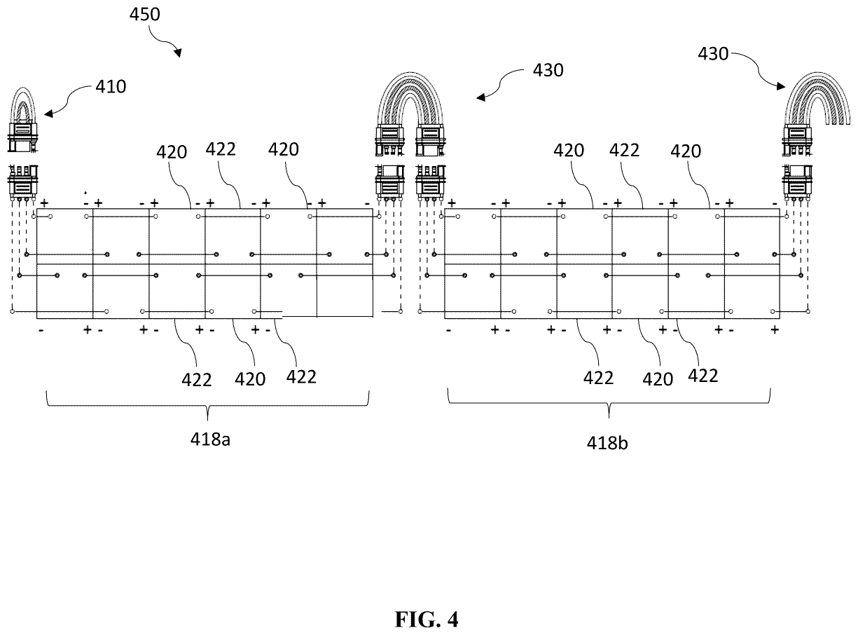

FIG. 4 is a diagrammatic view of an array of photovoltaic elements 450 electrically coupled, according to some embodiments. The array of photovoltaic elements 450 may include a first backplate array 418a of photovoltaic elements and a second backplate array 418b of photovoltaic elements. The first backplate array 418a and the second backplate array 418b may be indicative of the photovoltaic elements 350 mounted on adjacent backplates. The first backplate array 418a and the second backplate array 418b may include a first string of photovoltaic elements 420 and a second first string of photovoltaic elements 422. The first string of photovoltaic elements 420 may be electrically coupled together via conductive cables or vias and the second string of photovoltaic elements 422 may be electrically coupled together via conductive cables or vias. The first string of photovoltaic elements 420 may be in an alternating pattern with the second string of photovoltaic elements 422. The array of photovoltaic elements 450 may include a transition connector 430 between the first backplate array 418a of photovoltaic elements and the second backplate array 418b of photovoltaic elements. The array of photovoltaic elements 450 may include an end harness 410. The end harness 410 may couple the array of photovoltaic elements 450 to a through-roof enclosure 300.

In some embodiments, the array of photovoltaic elements 450 (i.e., the array of solar shingles) designed for maximum safety, roof coverage, and compliance with most adopted electrical codes and standards by maintaining no voltage (0V) until final step of installation and less than 80V unless system is turned on. In the embodiment shown in FIG. 4, each backplate array 418a, 418b consists of two circuits of six cells adding up to approximately 4 Voc each. Both circuits have no voltage (0V) while being installed since middle of each circuit remains open until the end harness 410 is inserted at beginning/end of strings. The positive lead from one cell connects to the negative lead of the cell two away, skipping the cell next to it. This is done for both circuits. Only when the system turns on do the circuits combine in series.

The array of photovoltaic elements 450, and namely, the two circuits maintaining 0V until the end harness 410 is coupled, is beneficial, as the BIPV system 100 may be installed with 0V on the circuits to improve safety of installation. The BIPV system 100 may acquire voltage only when the end harness 410 is installed at the end of the installation.

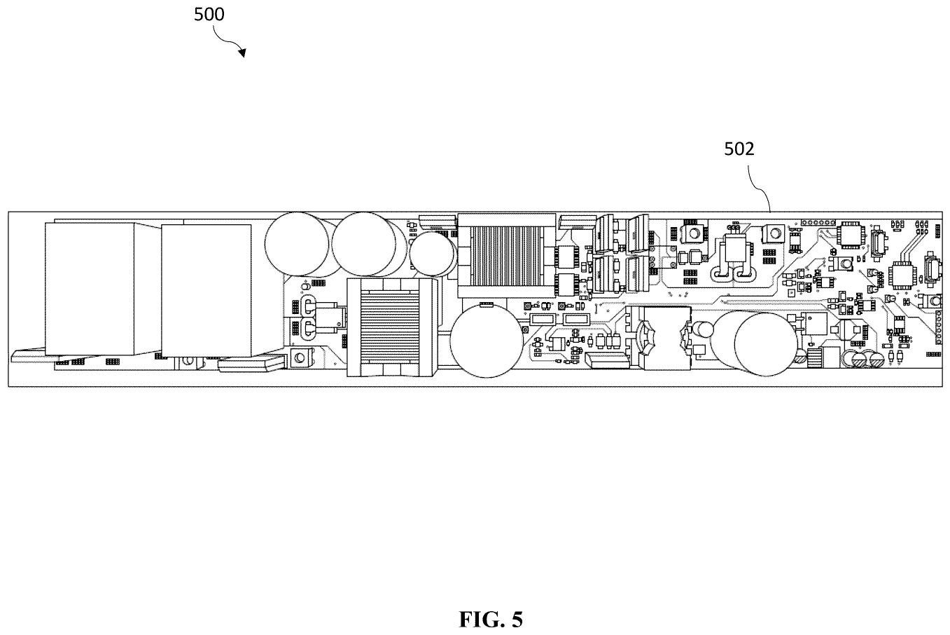

FIG. 5 is a diagrammatic top view of a micro inverter 500 for a building integrated photovoltaic (BIPV) system (e.g. the BIPV system 100), according to some embodiments. The micro inverter 500 may be received or housed within the through-roof enclosure 300. The micro inverter 500 includes a printed circuit board (PCB) 502 configured to convert 160 Vdc (nom) to 120 Vac RMS 60 Hertz pure sine wave (or otherwise as programmed by firmware) and/or store energy in in battery cells. Thermal energy from resistors, capacitors, MOSFETs, and other inverter and charge controlling components is managed by heat sinks, vias, silicone potting compound, transfer of heat through proprietary resin (>3 W/mK) battery tubes, and out the aluminum housing into free air. PCB layout in illustrations will be reconfigured to multi-layer to fit in enclosure space. The PCB 502 may include a plurality of thermo-conductive resin tubes 0.5″ (13 mm) in diameter by 10″ (254 mm) in length, each containing 5 LiFePO cells (10440 or AAA size) with battery management circuits. Rechargeable LiFePO cells can operate within their chemistry temperature tolerances because microinverter is in climate-controlled space rather than in intense heat of exposed roof; no other micro inverter is so engineered. Relay for combining circuits and DC disconnecting OCPD with ground fault circuit interruption (GFCI) and arc fault detection (AFD) are mounted on DIN rail. Touch-safe 20 A 120 Vac receptacle/output is housed in bottom plate.

The micro inverter 500 is configured to combine two 15 A 80 Vdc PV circuits into one 160 Vdc 15 A circuit when 120 Vac is sensed. The micro inverter 500 may be configured e-combines 160 Vdc circuit into two 80 Vdc in under 30 seconds when 120 Vac removed. A manual OCPD 2 pole (+,−) 160 Vdc 20 A breaker turns on inverter when AC connected. The micro inverter 500 may indicate presence of DC voltage when OCPD disconnect is closed. A ground fault circuit interruption and arc fault detection is included (e.g., via a red LED indicator). DC power is diverted to battery charge controller and 170 vdc (nom) battery bank when loads reduced and/or grid power takes over unless programmed otherwise. The micro inverter 500 may generate 120 Vac (rms) pure sine wave when DC on and AC detected, matches grid. DC power can come from either PV or battery, prioritizing >80% state of charge for optimal backup unless programmed otherwise for rate arbitrage, peak shaving, or IEEE 1547 grid support.

In some embodiments, the micro inverter 500 may include a rapid shutdown device (RSD). The RSD may be housed in the through-roof enclosure 300. Along with breaker 320 (e.g., the DC disconnect breaker), RSD comprises normally open relay that closes upon inverter sync with the distribution grid to combine two 80 Voc strings to one 160 Voc (15 A Isc). Under qualified electrical guidance, if the downstream equipment were suitable, two 80 Voc 15 A Isc strings could be internally hardwired into one 80 Voc 30 A Isc string provided that conductors at solar output are sized correctly and protected by proper OCPD.

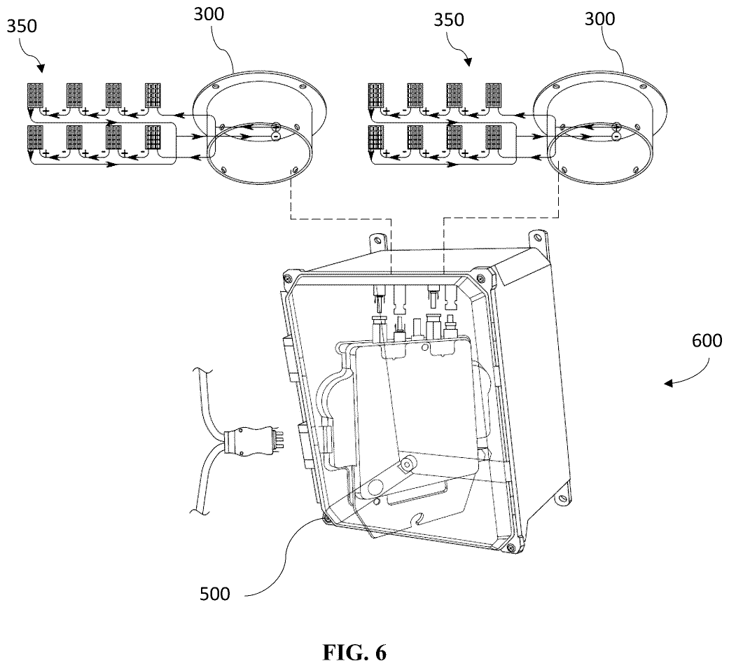

FIG. 6 is a diagrammatic view of an alternative mounting box 600 for a building integrated photovoltaic (BIPV) system (e.g. the BIPV system 100), according to some embodiments. The micro inverter 500 may be mounted in the alternative mounting box 600. Thus, the through-roof enclosure 300 may not need to house all associated electronic connectors and components, but rather, may route the solar energy to other systems within the building envelope.

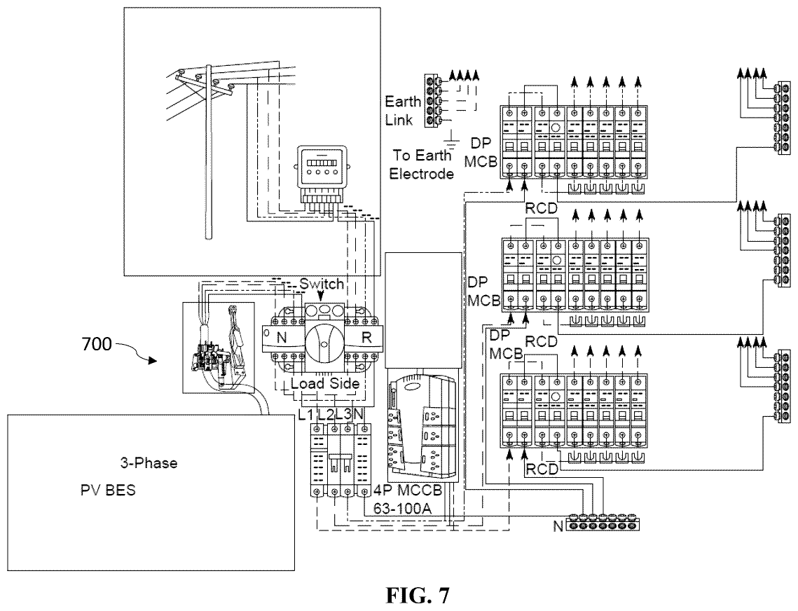

FIG. 7 is a diagrammatic view of a microgrid interconnect device 700 for a building integrated photovoltaic (BIPV) system (e.g. the BIPV system 100), according to some embodiments. The microgrid interconnect device 700 may include a wall-mounted three phase load center with 240 A rated bus, fused AC disconnect, automatic transfer switch (ATS), WiFi/ethernet module, and capability to serve loads depending on client requirements and jurisdictional rules. Single phase 125 A rated interconnection module may be developed for residential applications. No interconnection agreement is required with utility because back feed to grid is impossible without firmware reprogramming by manufacturer and/or installer.

The microgrid interconnect device 700 may be configured to provide three phase 120/208 Y (3 bus bars rated for 240 Amps). The microgrid interconnect device 700 may include twelve (12) micro inverter inputs (6 per phase split phase, 4 per phase 3 phase). Each input may be protected by 20 A single pole OCPD. PV/BESS serves protected loads or charges third party furnished uninterruptible power supply for critical load. The microgrid interconnect device 700 may include an automatic transfer switch: PV and/or BESS provide power as main; switches to grid power as reserve to allow PV/BESS to recharge as needed to maintain desired reserves. The microgrid interconnect device 700 may be equipped with levered fused disconnect for NEC 690.12 RSD between ATS and PV/BESS. When rapid shutdown utility AC disconnect in MID is activated/opened, inverters cease operating and drop string voltage below 80 Vdc in under 30 seconds. The microgrid interconnect device 700 may be quipped with at least 2×3 ph outs (6 slots), 3×240 Vac (6 slots), and 6×120 Vac (6 slots). Each output may be protected by OCPD (furnished by others/job electrician); some utilities and jurisdictions will not allow loads between inverter and utility meter if grid-tied. Wifi and ethernet communications hardware mounted within to enable communication with cloud-based app and utility API for IEEE1547.

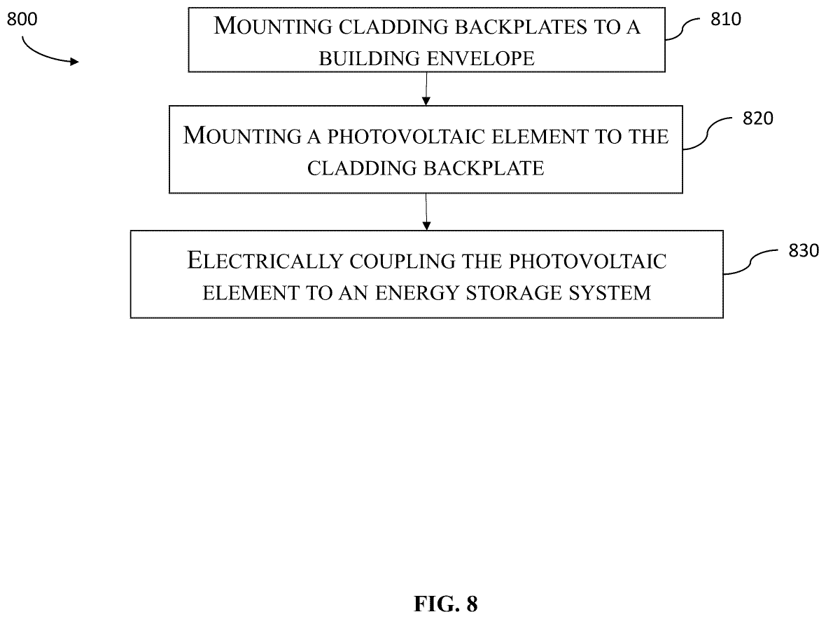

FIG. 8 is a flow chart of a method 800 for mounting photovoltaic elements to a building envelope, according to some embodiments. At step 810, the method 800 includes mounting a plurality of cladding backplates to the building envelope, each of the plurality of cladding backplates including a front surface having an upper ridge and a lower ridge with a recessed portion therebetween. The cladding backplates may include any and/or all feature of the cladding backplate 118, 218, 218a, 218b, 218c described above. At step 820, the method 800 may include mounting a photovoltaic element to the cladding backplate, wherein the photovoltaic element is received in the recessed portion of the cladding backplate. The photovoltaic element may include any and/or all features of the photovoltaic elements 350 described above. At step 830, the method 800 may include electrically coupling the photovoltaic element to an energy storage system via a cable. The method 800 may further include mounting a through-roof enclosure through the building envelope, wherein the through-roof enclosure is positioned between adjacent cladding backplates of the plurality of cladding backplates. The method may further include routing the cable via a front channel and a rear channel disposed on each of the plurality of cladding backplates to electrically couple the photovoltaic element to the energy storage system. The method may further include coupling the cable to the energy storage system via an end harness after mounting to the photovoltaic element to the cladding backplate to keep a voltage of a photovoltaic circuit 0V during installation.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

### DISCUSSION OF POSSIBLE EMBODIMENTS

The following are non-exclusive descriptions of possible embodiments of the present invention.

In some aspects, the techniques described herein relate to a building integrated photovoltaic (BIPV) system, including: a plurality of photovoltaic elements; a cable coupling the plurality of photovoltaic elements to an energy storage; and a plurality of cladding backplates to secure the plurality of photovoltaic elements to a building envelope, each of the cladding backplates including: an upper ridge and a lower ridge to secure the photovoltaic element therebetween, a connection tab positioned on a lateral side of the cladding backplate, and a channel extending into the cladding backplate to receive the cable therein.

In some aspects, the techniques described herein relate to a BIPV system, further including a through-roof enclosure extending through the building envelope.

In some aspects, the techniques described herein relate to a BIPV system, wherein the through-roof enclosure includes a cover having an aperture to receive the cable therethrough.

In some aspects, the techniques described herein relate to a BIPV system, wherein the through-roof enclosure is positioned between adjacent cladding backplates, wherein the connection tab is recessed to provide a cable raceway for the cable to extend from the plurality of photovoltaic elements to the through-roof enclosure.

In some aspects, the techniques described herein relate to a BIPV system, further including DC disconnect breaker disposed in the through-roof enclosure.

In some aspects, the techniques described herein relate to a BIPV system, wherein the cladding backplate includes an alignment tab on a front surface, wherein the connection tab includes a channel configured to receive the alignment tab of an adjacent cladding backplate.

In some aspects, the techniques described herein relate to a BIPV system, wherein the cladding backplate includes an upper surface, wherein the connection tab includes a ridge on the rear surface configured to engage the upper surface of an adjacent cladding backplate.

In some aspects, the techniques described herein relate to a BIPV system, wherein the cladding backplate includes: a front attachment member positioned on a front surface having a through-plate aperture, and a rear attachment member positioned on the rear surface, wherein the through-plate aperture of the cladding backplate is configured to receive the rear attachment member of an adjacent backplate.

In some aspects, the techniques described herein relate to a BIPV system, wherein the cladding backplate includes plurality of first mounting apertures configured to receive a fastener therethrough to secure the cladding backplate to the building envelope.

In some aspects, the techniques described herein relate to a BIPV system, wherein the channel is configured to route the cable away from the plurality of first mounting apertures.

In some aspects, the techniques described herein relate to a cladding backplate for securing photovoltaic elements to a building envelope, the cladding backplate including: a front surface including an upper ridge and a lower ridge with a recessed portion therebetween to receive a photovoltaic element, and a front channel extending into the front surface; a rear surface including a rear channel extending into the rear surface; and a connection tab positioned on a lateral side of the cladding backplate, wherein the front channel and the rear channel form a cable raceway to retain a cable from the photovoltaic element.

In some aspects, the techniques described herein relate to a cladding backplate, wherein the front channel and the rear channel are in communication via an opening adjacent to the connection tab.

In some aspects, the techniques described herein relate to a cladding backplate, further including a through-plate aperture, wherein a rear attachment member extending from the rear surface is configured to be received within the through-plate aperture.

In some aspects, the techniques described herein relate to a cladding backplate, wherein the lower ridge includes a plurality of lower tabs configured to engage the photovoltaic element.

In some aspects, the techniques described herein relate to a cladding backplate, wherein the upper ridge includes a plurality of upper tabs configured to retain the photovoltaic element within the recessed portion.

In some aspects, the techniques described herein relate to a cladding backplate, wherein the connection tab includes an alignment channel and an alignment ridge to engage and align an adjacent cladding backplate.

In some aspects, the techniques described herein relate to a method for mounting photovoltaic elements to a building envelope, the method including: mounting a plurality of cladding backplates to the building envelope, each of the plurality of cladding backplates including a front surface having an upper ridge and a lower ridge with a recessed portion therebetween; mounting a photovoltaic element to the cladding backplate, wherein the photovoltaic element is received in the recessed portion of the cladding backplate; and electrically coupling the photovoltaic element to an energy storage system via a cable.

In some aspects, the techniques described herein relate to a method, further including: mounting a through-roof enclosure through the building envelope, wherein the through-roof enclosure is positioned between adjacent cladding backplates of the plurality of cladding backplates.

In some aspects, the techniques described herein relate to a method, further including: routing the cable via a front channel and a rear channel disposed on each of the plurality of cladding backplates to electrically couple the photovoltaic element to the energy storage system.

In some aspects, the techniques described herein relate to a method, further including: coupling the cable to the energy storage system via an end harness after mounting to the photovoltaic element to the cladding backplate to keep a voltage of a photovoltaic circuit 0V during installation.

1. A building integrated photovoltaic (BIPV) system, comprising:
a plurality of photovoltaic elements;
a cable electrically coupling the plurality of photovoltaic elements to an energy storage; and
a plurality of cladding backplates to secure the plurality of photovoltaic elements to a building envelope, each of the cladding backplates including:
an upper ridge and a lower ridge to secure the photovoltaic element therebetween,
a connection tab positioned on a lateral side of the cladding backplate, and
a channel extending into the cladding backplate to receive the cable therein.

2. The BIPV system of claim 1, further comprising a through-roof enclosure extending through the building envelope.

3. The BIPV system of claim 2, wherein the through-roof enclosure includes a cover having an aperture to receive the cable therethrough.

4. The BIPV system of claim 3, wherein the through-roof enclosure is positioned between adjacent cladding backplates, wherein the connection tab is recessed to provide a cable raceway for the cable to extend from the plurality of photovoltaic elements to the through-roof enclosure.

5. The BIPV system of claim 2, further comprising DC disconnect breaker disposed in the through-roof enclosure.

6. The BIPV system of claim 1, wherein the cladding backplate includes an alignment tab on a front surface, wherein the connection tab includes a channel configured to receive the alignment tab of an adjacent cladding backplate.

7. The BIPV system of claim 1, wherein the cladding backplate includes an upper surface, wherein the connection tab includes a ridge on a rear surface configured to engage the upper surface of an adjacent cladding backplate.

8. The BIPV system of claim 1, wherein the cladding backplate includes:
a front attachment member positioned on a front surface having a through-plate aperture, and
a rear attachment member positioned on the rear surface,
wherein the through-plate aperture of the cladding backplate is configured to receive the rear attachment member of an adjacent backplate.

9. The BIPV system of claim 1, wherein the cladding backplate includes plurality of first mounting apertures configured to receive a fastener therethrough to secure the cladding backplate to the building envelope.

10. The BIPV system of claim 9, wherein the channel is configured to route the cable away from the plurality of first mounting apertures.

11. A cladding backplate for securing photovoltaic elements to a building envelope, the cladding backplate comprising:
a front surface including an upper ridge and a lower ridge with a recessed portion therebetween to receive a photovoltaic element, and a front channel extending into the front surface;
a rear surface including a rear channel extending into the rear surface; and
a connection tab positioned on a lateral side of the cladding backplate,
wherein the front channel and the rear channel form a cable raceway to retain a cable from the photovoltaic element.

12. The cladding backplate of claim 11, wherein the front channel and the rear channel are in communication via an opening adjacent to the connection tab.

13. The cladding backplate of claim 11, further comprising a through-plate aperture, wherein a rear attachment member extending from the rear surface is configured to be received within the through-plate aperture.

14. The cladding backplate of claim 11, wherein the lower ridge includes a plurality of lower tabs configured to engage the photovoltaic element.

15. The cladding backplate of claim 14, wherein the upper ridge includes a plurality of upper tabs configured to retain the photovoltaic element within the recessed portion.

16. The cladding backplate of claim 11, wherein the connection tab includes an alignment channel and an alignment ridge to engage and align an adjacent cladding backplate.

17. A method for mounting photovoltaic elements to a building envelope, the method comprising:
mounting a plurality of cladding backplates to the building envelope, each of the plurality of cladding backplates including a front surface having an upper ridge and a lower ridge with a recessed portion therebetween;
mounting a photovoltaic element to the cladding backplate, wherein the photovoltaic element is received in the recessed portion of the cladding backplate; and
electrically coupling the photovoltaic element to an energy storage system via a cable.

18. The method of claim 17, further comprising:
mounting a through-roof enclosure through the building envelope, wherein the through-roof enclosure is positioned between adjacent cladding backplates of the plurality of cladding backplates.

19. The method of claim 17, further comprising:
routing the cable via a front channel and a rear channel disposed on each of the plurality of cladding backplates to electrically couple the photovoltaic element to the energy storage system.

20. The method of claim 17, further comprising:
coupling the cable to the energy storage system via an end harness after mounting to the photovoltaic element to the cladding backplate to keep a voltage of a photovoltaic circuit 0V during installation.
